(19) United States
(12) Patent Application Publication
(10) Pub. No.: US 2026/0364683 A1
(43) Pub. Date: Nov. 19, 2026

(54) CONTROLLING MACHINABILITY IN METAL THREE-DIMENSIONAL PRINTING

(71) Applicant: International Business Machines Corporation, Armonk, NY (US)

(72) Inventors: Jessica NAHULAN, Vaughan (CA); Sarbajit Kumar RAKSHIT, Kolkata (IN); Tiberiu SUTO, Franklin, NY (US); Michael BOONE, Lutz, FL (US)

(21) Appl. No.: 19/207,994

(22) Filed: May 14, 2025

(51) Int. Cl. B22F 10/80; B22F 10/368; B22F 12/88; B33Y 50/00

(52) U.S. Cl. CPC B22F 10/80; B22F 10/368; B22F 12/88; B33Y 50/00

(57) ABSTRACT

A computer system may receive a digital model of a three-dimensional (3D) object to be printed with a metal by a 3D printer, and may analyze the digital model to identify portions of the 3D object to be machined and machining operations to be performed on the portions. The computer system may segment the digital model based on the portions and the machining operations and to generate digital model segments, and may determine a handling operation for each of the digital model segments based on one of the portions and one of the machining operations corresponding to each of the digital model segments and to generate handling operations. The computer system may process the digital model segments, the portions, the machining operations, and the handling operations, with a machine learning model, to generate machinability parameters for the 3D printer, and may provide the machinability parameters to the 3D printer.

### BACKGROUND

Metal three-dimensional (3D) printing is a manufacturing technique that involves layer-by-layer deposition of metal materials to create objects. Various factors are considered when selecting materials for use in metal 3D printing applications.

### SUMMARY

Some aspects described herein relate to a method. The method may include receiving a digital model of a 3D object to be printed with a metal by a 3D printer, and analyzing the digital model to identify portions of the 3D object to be machined and machining operations to be performed on the portions. The method may include segmenting the digital model based on the portions and the machining operations and to generate digital model segments, and determining a handling operation for each of the digital model segments based on one of the portions and one of the machining operations corresponding to each of the digital model segments and to generate handling operations. The method may include processing the digital model segments, the portions, the machining operations, and the handling operations, with a machine learning model, to generate machinability parameters for the 3D printer, and providing the machinability parameters to the 3D printer.

Some aspects described herein relate to a computer system. The computer system may include a processor set, one or more computer-readable storage media, and program instructions stored on the one or more computer-readable storage media to cause the processor set to perform operations. The operations may include receiving a digital model of a 3D object to be printed with a metal by a 3D printer, and analyzing the digital model to identify portions of the 3D object to be machined and machining operations to be performed on the portions. The operations may include segmenting the digital model based on the portions and the machining operations and to generate digital model segments, and determining a handling operation for each of the digital model segments based on one of the portions and one of the machining operations corresponding to each of the digital model segments and to generate handling operations. The operations may include processing the digital model segments, the portions, the machining operations, and the handling operations, with a machine learning model, to generate machinability parameters for the 3D printer, and providing the machinability parameters to the 3D printer to cause the 3D printer to print the 3D object with the metal.

Some aspects described herein relate to a computer program product. The computer program product may include one or more computer-readable storage media and program instructions stored on the one or more computer-readable storage media to perform operations. The operations may include receiving a digital model of a 3D object to be printed with a metal by a 3D printer, and analyzing the digital model to identify portions of the 3D object to be machined and machining operations to be performed on the portions. The operations may include segmenting the digital model based on the portions and the machining operations and to generate digital model segments, and determining a handling operation for each of the digital model segments based on one of the portions and one of the machining operations corresponding to each of the digital model segments and to generate handling operations. The operations may include processing the digital model segments, the portions, the machining operations, and the handling operations, with a machine learning model, to generate machinability parameters for the 3D printer, and providing the machinability parameters to the 3D printer. The operations may include receiving feedback associated with printing of the 3D object from the 3D printer, and updating the machinability parameters based on the feedback and to generate updated machinability parameters. The operations may include providing the updated machinability parameters to the 3D printer.

### BRIEF DESCRIPTION OF THE DRAWINGS

FIG. 1 is a diagram of an example computing environment for controlling machinability in metal 3D printing, as described herein.

FIGS. 2A-2G are diagrams of an example associated with controlling machinability in metal 3D printing.

FIG. 3 is a flowchart of an example process associated with controlling machinability in metal 3D printing.

### DETAILED DESCRIPTION

The following detailed description of example implementations refers to the accompanying drawings. The same reference numbers in different drawings may identify the same or similar elements.

Machining is a crucial process in manufacturing that involves the removal of material from a workpiece to create a desired shape or design. However, a machinability of a material, which refers to its ease of being cut or shaped, is often a limiting factor in machining operations. Materials with poor machinability may cause rapid tool wear, lead to frequent tool replacement, and increase production costs. Machinability often comes at the expense of material performance, and vice versa. Strong materials are typically harder to cut than weak materials, so engineers often need to make a tradeoff between machinability and performance. The machinability of a given material is dependent on both scientific physical properties of a material group (e.g., what elements it consists of) and a condition of a specific work material (e.g., how it has been made). The physical properties of a material are fixed, but the condition of a workpiece can vary greatly. The physical properties may include work hardening, thermal expansion, thermal conductivity, and modulus of elasticity. Condition factors may include microstructure, grain size, heat treatment, hardness, and tensile strength.

Machinability is a critical consideration when selecting materials for manufacturing or mechanical applications. Several factors affect machinability. For example, cutting properties may affect machinability because some materials are harder to cut than others due to differences in hardness, toughness, or other mechanical properties. Tool wear may affect machinability because materials with poor machinability may cause rapid tool wear, leading to frequent tool replacement and increased production costs. Tool life is an important factor in assessing machinability since it directly ties to computer numerical control (CNC) manufacturing machines, maintenance labor, and tooling costs. Surface finish may affect machinability because the ability to achieve a smooth and precise surface finish on a workpiece is an essential aspect of machinability. Materials that tend to produce rough or irregular surfaces may require more post-processing for even surface finishing such as powder coating. The formation and evacuation of chips (e.g., material that is removed during machining) may affect machinability. Some materials produce chips that are easy to manage, while others create problems like chip recutting, which can affect machining efficiency associated with production runs. Thermal conductivity may affect machinability because materials with high thermal conductivity can dissipate heat more effectively, reducing the risk of overheating and improving tool life. Chemical reactivity may affect machinability since some materials are chemically reactive with cutting fluids or tool materials, which can affect machining processes. Compatibility with cutting fluids and tool materials is an important consideration when choosing a raw material for CNC machining. Abrasiveness may affect machinability since the presence of abrasive elements in a material can cause rapid tool wear and hinder machinability. Abrasive materials can damage cutting tools quickly which leads to extra costs associated with CNC tooling replacements and labor for maintenance and upkeep. Work hardening may affect machinability because certain materials may undergo work hardening during machining, making them more challenging to cut as the process progresses. In materials science, work hardening, also known as strain hardening, is the strengthening of a metal or polymer by plastic deformation, which lengthens the production time, increases wearing on tooling, and reduces efficiency of CNC output capabilities. Tool material and coatings may affect machinability since using appropriate tool materials and coatings can help mitigate some of the challenges presented by difficult-to-machine materials.

A microstructure of a material may significantly influence its machinability properties. “Microstructure” refers to the arrangement and characteristics of the microscopic constituents within a material, such as grains and defects. For example, materials with finer grain structures exhibit improved machinability. Fine grains reduce tool wear and enhance surface finish by promoting uniform deformation during machining, whereas coarser grains can lead to uneven chip formation and increased cutting forces, negatively affecting machinability. Uniform hardness across the microstructure contributes to consistent tool wear and predictable machining behavior, whereas variations in hardness, such as localized hard spots, can lead to uneven tool wear and may result in tool failure. Materials prone to work hardening during machining may experience increased cutting forces and reduced machinability. Annealing or selecting materials with lower work hardening rates can improve machinability. Residual stresses from previous manufacturing processes or heat treatments can affect material response during machining. Stress relief treatments may improve machinability.

While metal 3D printing is performed, properties of a material may change. For example, a grain structure of a material in a 3D printed object may change during printing. A cooling rate may control the grain structure. During 3D printing, selective hardening can be achieved on a 3D printed object. Various alloy formations, a microstructure, and a cooling rate of a 3D printed object may alter the hardness properties of the 3D printed material. Surface hardening of a 3D printed object may occur and may depend on heat treatment and cooling rate. During 3D printing of any object, improper cooling can generate residual stresses on different portions of the 3D printed object.

3D printed metal objects often undergo different types of machining processes to achieve precise dimensions, improve surface finish, and meet specific requirements. The machining processes may refine the final product or may be used for optimizing the manufacturing process. 3D printing is slow while making precise dimensions, and machining is faster. Examples of machining required for a 3D printed metal object may include milling, turning, drilling, grinding, laser cutting, polishing, and/or the like.

Traditional metal 3D printing processes can exacerbate machinability issues, as the printed material's microstructure and properties may not be optimized for machining. Furthermore, different regions of a 3D printed object may require different machining operations, such as drilling, milling, or grinding, which can be challenging to accomplish efficiently. Thus, current methods for metal 3D printing consume computing resources (e.g., processing resources, memory resources, communication resources, and/or the like), networking resources, and/or the like associated with causing rapid tool wear in metal 3D printers, frequently replacing metal 3D printers due to rapid tool wear, constantly maintaining metal 3D printers, failing to properly perform different machining operations with metal 3D printers, and/or the like.

Some implementations described herein provide a computer system for controlling machinability in metal 3D printing. For example, the computer system may receive a digital model of a 3D object to be printed with a metal by a 3D printer, and may analyze the digital model to identify portions of the 3D object to be machined and machining operations to be performed on the portions. The computer system may segment the digital model based on the portions and the machining operations and to generate digital model segments, and may determine a handling operation for each of the digital model segments based on one of the portions and one of the machining operations corresponding to each of the digital model segments and to generate handling operations. The computer system may process the digital model segments, the portions, the machining operations, and the handling operations, with a machine learning model, to generate machinability parameters for the 3D printer, and may provide the machinability parameters to the 3D printer.

In this way, the computer system controls machinability in metal 3D printing. For example, the computer system may provide optimized metal 3D printing for machinability. The computer system may efficiently identify relevant machining operations and machinability parameters, which may lead to less wear and tear on 3D printers. The computer system may also optimize instructions used by a 3D printer to create the 3D object. By optimizing the machining operations, the machinability parameters, and the instructions, the computer system may minimize 3D printer energy consumption, decrease failure rates in metal 3D printing, and improve print throughput and yield rates. Additionally, the computer system may utilize a feedback control loop to iteratively refine the machinability parameters used by the 3D printer, which may reduce latency times, improve print quality, and maintain optimal machining conditions during the 3D printing process. Thus, the computer system conserves computing resources, networking resources, and/or the like that would otherwise have been consumed by causing rapid tool wear in metal 3D printers, frequently replacing metal 3D printers due to rapid tool wear, constantly maintaining metal 3D printers, failing to properly perform different machining operations with metal 3D printers, and/or the like.

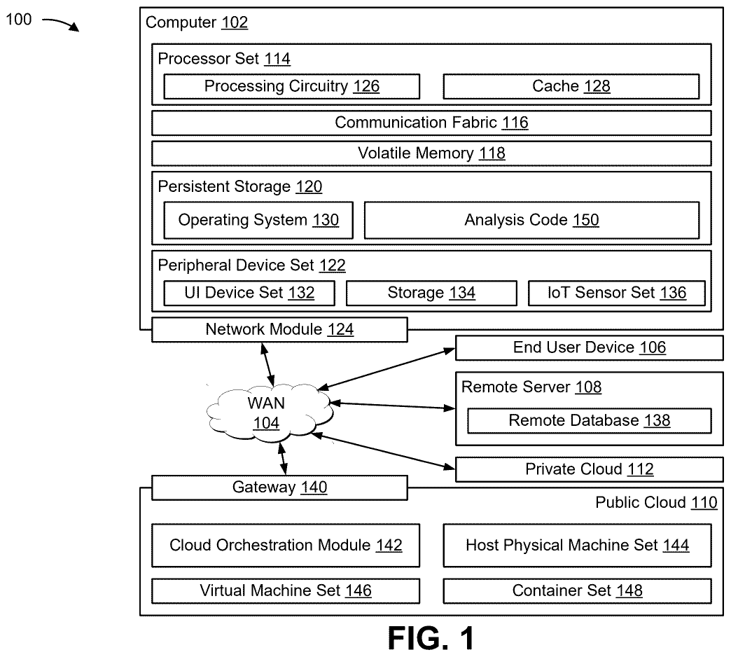

FIG. 1 is a diagram of an example computing environment 100 for controlling machinability in metal 3D printing, as described herein.

Computing environment 100 contains an example of an environment for the execution of at least some of the computer code involved in performing the inventive methods, such as analysis code 150 (e.g., code for controlling machinability in metal 3D printing). In addition to analysis code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and analysis code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in analysis code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

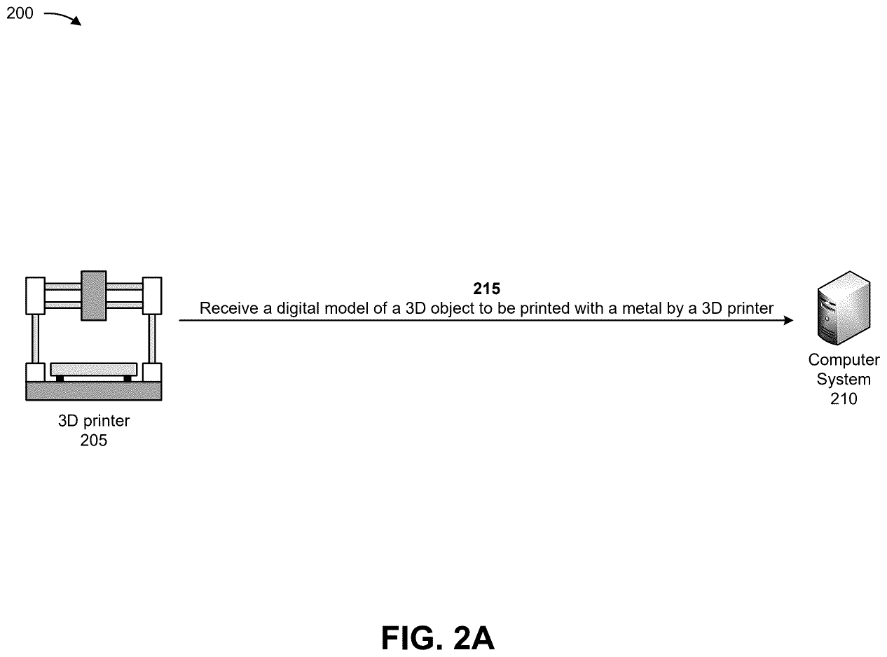

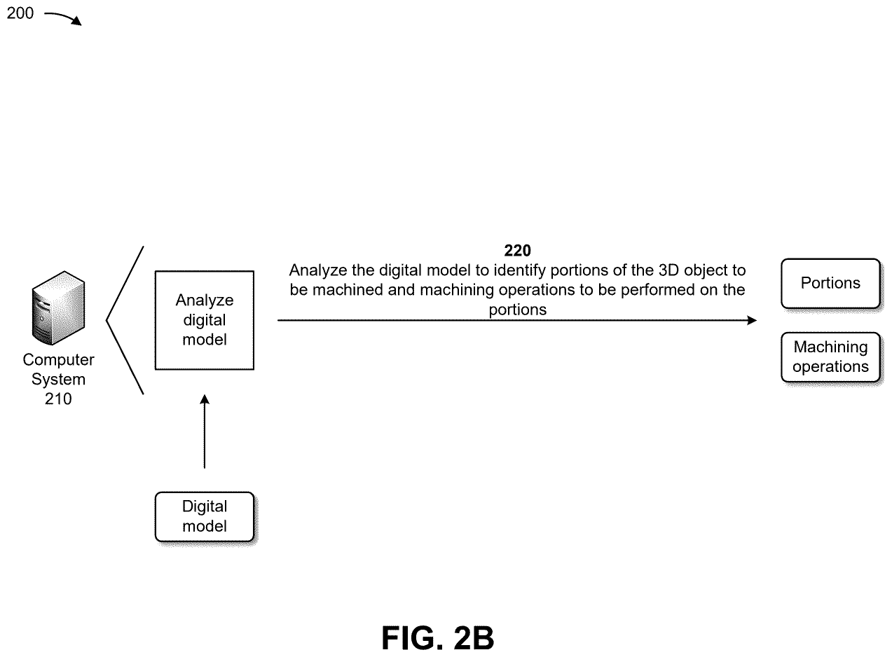

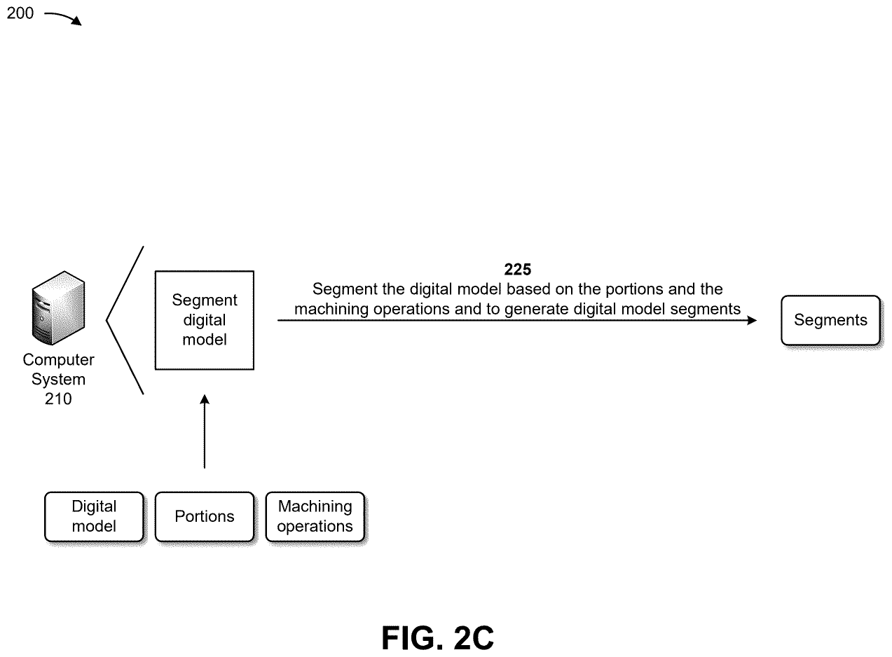

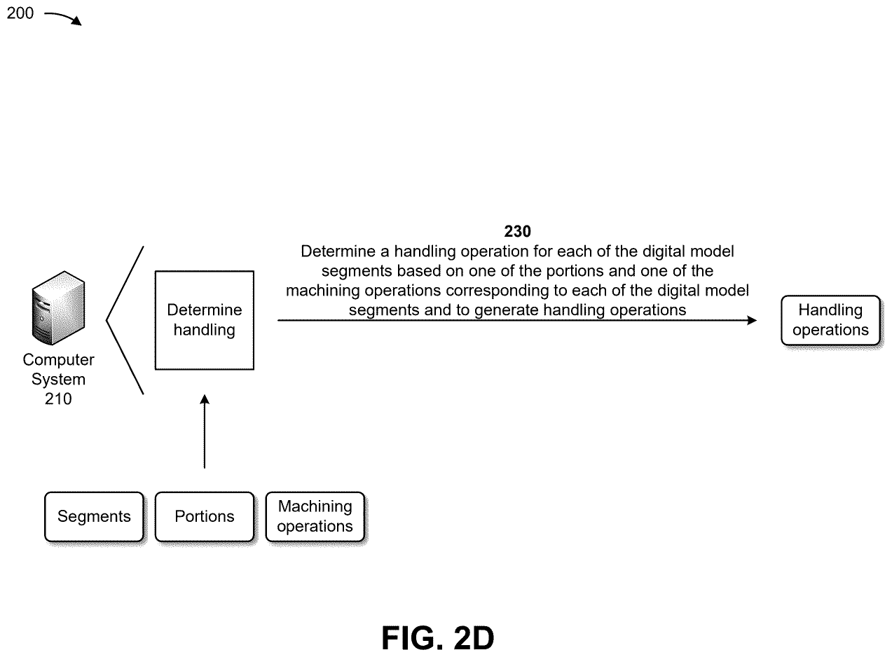

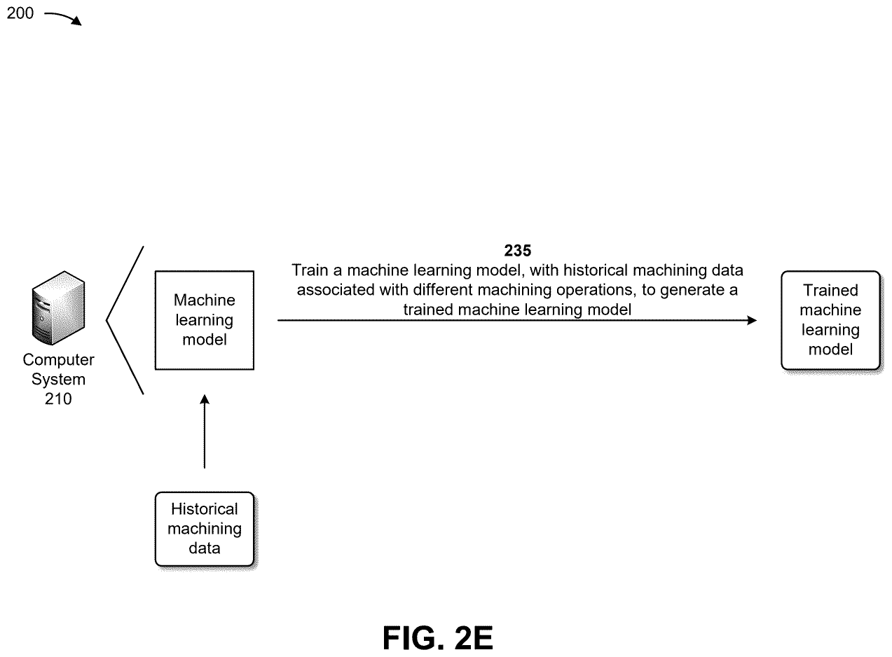

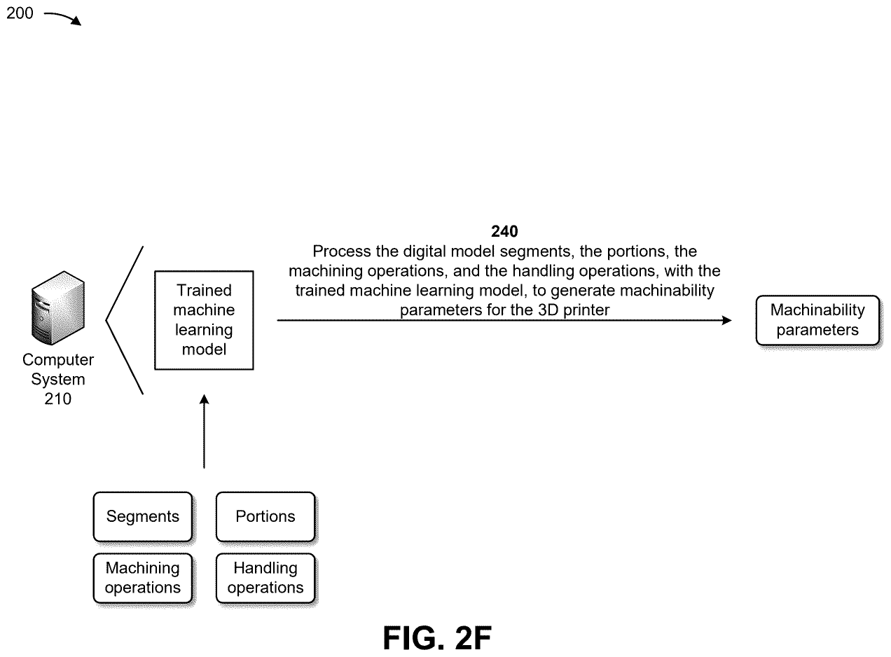

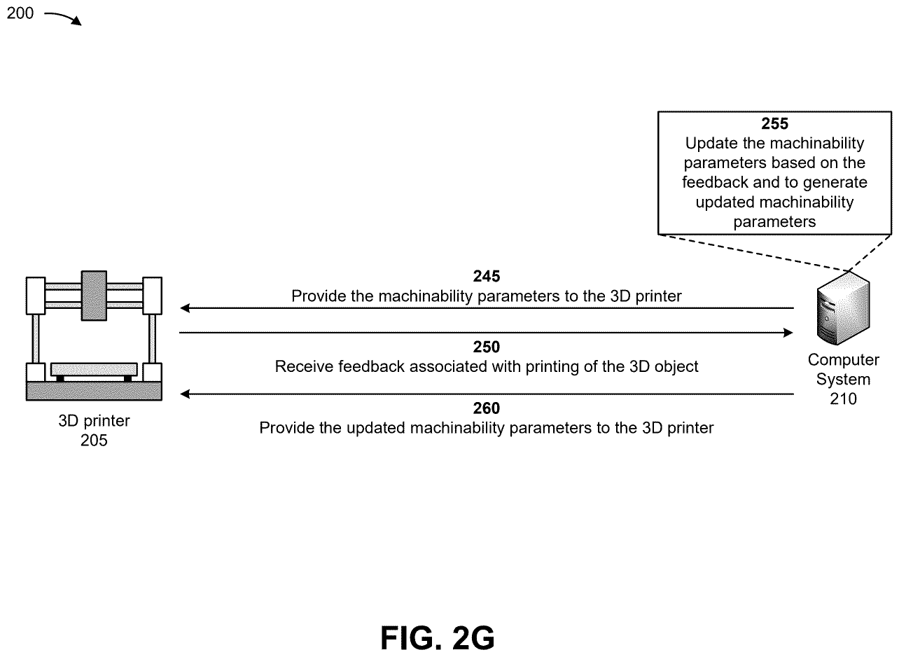

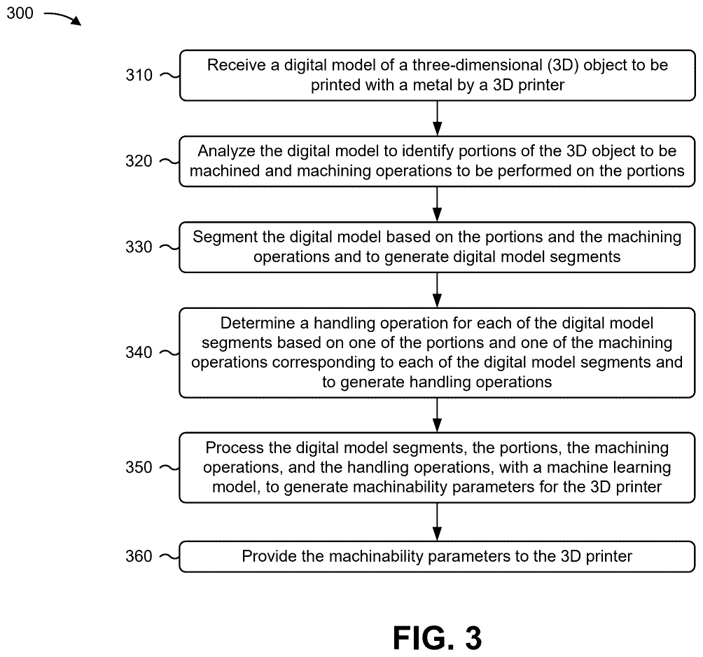

The code included in the analysis code 150 typically includes at least some of the computer code involved in performing one or more operations described herein, such as the operations of implementation 200 in FIGS. 2A-2G and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

As used herein, the term “G-code” may include a programming language used to control 3D printers and other CNC machines. G-code may include a series of commands that instruct the 3D printer on where to move, how fast to move, and when to extrude material. For example, the commands may include machine-level instructions required to print an object (e.g., “move print head to location X, Y” or “extrude Z amount of material”). M-code (e.g., a programming language used in machines) may also be utilized in CNC machining, and may be utilized with G-code to control various machine functions that are not directly related to the motion of the tool.

As used herein, the term “slicer” may include a software tool that can convert user-designed 3D models into G-code instructions. In the context of 3D printing, a slicer may include specialized software that converts a digital 3D model into instructions (e.g., typically in G-code format) that a 3D printer can execute to create a physical object.

In some implementations, the steps to print a 3D object may include creating a 3D model using computer-aided design (CAD) software; converting the 3D model to a format readable by the slicer software; utilizing the slicer software to generate G-code or M-code, which slices the model into layers, calculates optimal print head paths, and generates G-code or M-code commands for each layer; and utilizing the G-code or M-code with a 3D printer. A 3D printer may have knowledge of an available print area based on firmware utilized by the 3D printer. There are several different types of firmware available for each 3D printer, and such firmware may enable parameters such as print bed size to be adjusted to obtain an absolute maximum print area.

As used herein, the terms “three-dimensional printing” or “3D printing” may include five-dimensional (5D) printing or two-dimensional (2D) printing. Depending on requirements of a digital model being printed, 3D printing may utilize many different types of metals, such as steel, bronze, copper, and/or the like.

FIGS. 2A-2G are diagrams of an example 200 associated with controlling machinability in metal 3D printing. As shown in FIGS. 2A-2G, the example 200 includes a 3D printer 205 associated with a computer system 210. The 3D printer 205 may include a machine that creates physical objects from digital designs by layering materials, such as plastics, metals, ceramics, and/or the like. The computer system 210 may correspond to the computer 102, the remote server 108, a system provided by the public cloud 110, and/or a system provided by the private cloud 112. Further details of the 3D printer 205 and the computer system 210 are provided elsewhere herein.

As shown in FIG. 2A, and by reference number 215, the computer system 210 may receive a digital model of a 3D object to be printed with a metal by the 3D printer 205. For example, the 3D printer 205 may create a 3D CAD model of the 3D object. A 3D CAD model may include a digital representation of a physical object or design created using CAD software. The computer system 210 may utilize the 3D CAD model to instruct the 3D printer 205 on how to create the 3D object. In some implementations, when the 3D printer 205 creates the digital model, the 3D printer 205 may provide the digital model to the computer system 210, and the computer system 210 may receive the digital model from the 3D printer 205. Alternatively, a user may utilize the computer system 210 to generate the digital model, and the computer system 210 may receive the digital model from the user (e.g., via inputs or via a user device utilized by the user). Alternatively, the computer system 210 may receive the digital model from another source, such as a system using CAD software.

In some implementations, the digital model may include a CAD format, such as a standard for the exchange of product model data (STEP) format or a stereolithography (STL) format. The computer system 210 may preprocess the digital model to extract relevant geometric and topological information. This may include converting the CAD file into a more suitable format for analysis, such as a polygon mesh or a non-uniform rational B-spline (NURBS) representation.

As shown in FIG. 2B, and by reference number 220, the computer system 210 may analyze the digital model to identify portions of the 3D object to be machined and machining operations to be performed on the portions. For example, the computer system 210 may apply feature extraction and recognition techniques to the digital model to identify specific features of the 3D object, such as geometric features (e.g., edges, vertices, faces, holes, pockets, and curves), topological features (e.g., connectivity, adjacency, and boundary relationships between geometric features), and semantic features (e.g., functional elements, such as shafts, gears, and bearings). The computer system 210 uses models to identify the features of the 3D object, such as an edge detection and tracking model, a face recognition and clustering model, a vertex classification and filtering model, a graph-based model for topological analysis, and/or the like.

Based on the extracted features, the computer system 210 may identify the machining operations required to manufacture the 3D object. For example, the computer system 210 may analyze the geometric and topological features to determine the type of machining operations needed, such as milling (e.g., for flat or curved surfaces), drilling (e.g., for holes and pockets), grinding (e.g., for surface finishing), turning (e.g., for rotational features, such as shafts), and/or the like. The computer system 210 may recognize specific machining patterns and features, such as pockets with rounded corners, drilled holes with chamfers, milled surfaces with specific textures or patterns, and/or the like. In order to identify the machining operations, the computer system 210 may utilize a rule-based system that applies predefined rules and heuristics to match features with machining operations, a machine learning model that is trained on datasets of machining operations and features to predict the required machining operations, and/or case-based reasoning that retrieves and adapts solutions from a database of previously analyzed 3D objects.

In some implementations, the computer system 210 may identify the specific portions of the 3D object that require machining operations. This may include segmenting the digital model into regions based on the identified machining operations and features, determining the boundaries and interfaces between these regions, creating a hierarchical representation of the 3D object, with each portion represented as a separate entity, and/or the like. The computer system 210 may utilize a clustering model (e.g., that groups features and operations based on proximity, similarity, or functionality), a graph partitioning (e.g., that divides the digital model into subgraphs representing individual portions), constructive solid geometry (e.g., that represents the 3D object as a hierarchy of simple shapes and operations), and/or the like to identify the portions of the 3D object that require machining operations.

In some implementations, when identifying portions of the 3D object to be machined, the computer system 210 may apply a feature recognition model trained on a dataset of common machining features, such as holes, pockets, chamfers, and fillets. The feature recognition model may use techniques such as support vector machines or random forests to classify and label these features based on their geometric attributes. The identified features may be mapped to corresponding machining operations using a rule-based system or a trained decision tree model.

The computer system 210 may generate a sequence of machining operations for each portion, taking into account factors such as 3D printer 205 accessibility and collision avoidance, surface finish and quality requirements, material removal rates and optimal toolpath planning, 3D printer 205 capabilities and limitations, and/or the like. To generate the sequence of machining operations for each portion, the computer system 210 may utilize a scheduling model (e.g., that allocates machining operations), process planning (e.g., that generates a sequence of operations based on manufacturability constraints and heuristics), simulation and verification (e.g., that checks a feasibility and accuracy of the machining operations), and/or the like.

In some implementations, the computer system 210 may identify different types of post-3D printing machining operations, such as drilling, milling, grinding, and turning, to be performed on the portions of the 3D object. Based on the analysis of the digital model, the computer system 210 may assess an overall geometry and complexity of the digital model, and may identify intricate features, overhangs, and areas with complex geometries. The computer system 210 may identify the portions of the 3D object to be completed by the 3D printer 205, and portions of the 3D object which will require machining. The computer system 210 may identify which metal is to be used for 3D printing, and may identify a specification of the metal, such as hardness, thermal stability, machinability, and/or the like. The computer system 210 may determine different types of machining operations for different portions of the 3D object. The different types of machining operations may require different amounts of cutting force, different material removal rates, different material feed rates, and/or the like. A shape and dimensions of the 3D printer 205 may also be considered when determining the different types of machining operations. Based on historical data associated with different types of machining operations, the computer system 210 may determine microstructure properties of the 3D object, an amount of cutting force required for the 3D object, wear and tear of cutting tools, and/or the like. Based on the different types of machining operations and the material specification, the computer system 210 may determine a level of machinability of a portion of the 3D object where machining is required.

In some implementations, the computer system 210 may collect historical hardness data at various points during the processing of a metal or a metal alloy, and may utilize the historical hardness data to generate a digital twin model of a metal or a metal alloy. The computer system 210 may map associations between factors that change the properties of a material (e.g., heating, cooling, application of various other substances to the surface, and/or the like) and a quantity of change detected for each factor. In some implementations, the digital twin model may be enhanced with crowdsourced data received from multiple entities working with similar materials.

As shown in FIG. 2C, and by reference number 225, the computer system 210 may segment the digital model based on the portions and the machining operations and to generate digital model segments. For example, the computer system 210 may utilize the identified portions and machining operations to detect boundaries between the portions. This may include analyzing the geometric and topological features of the digital model to determine interfaces between portions, identifying the curves, edges, or surfaces that separate the portions, creating a boundary representation for each portion (e.g., using edge detection and tracking, face recognition and clustering, and/or vertex classification and filtering), and/or the like. For each portion, the computer system 210 may extract and reconstruct relevant surfaces, taking into account geometric features (e.g., surface normal, curvature, and anomalies), topological features (e.g., connectivity, adjacency, and boundary relationships between surfaces), and the machining operations (e.g., required surface finish, texture, and tolerances), and/or the like. To extract and reconstruct the surfaces, the computer system 210 may utilize surface fitting and reconstruction (e.g., approximating the underlying surface geometry using techniques like NURBS or Catmull-Clark subdivision), surface meshing (e.g., discretizing the surface into a polygon mesh or a set of connected triangles), and/or surface feature analysis (e.g., identifying and preserving surface features, such as edges, corners, and holes).

The computer system 210 may segment the digital model into volumes corresponding to each portion, using geometric Boolean operations (e.g., performing intersections, unions, and differences between surfaces and solids to create volume segments), topological analysis (e.g., identifying the relationships between volumes, surfaces, and edges), and/or graph-based methods (e.g., representing the digital model as a graph of connected nodes and edges, and segmenting the graph into subgraphs representing each portion). For each portion, the computer system 210 may generate a digital model segment that includes geometric data (e.g., surfaces, edges, and vertices defining the shape of the portion), topological data (e.g., connectivity and adjacency relationships between geometric features), and machining operation data (e.g., specified machining operations, toolpaths, and parameters for the portion). The computer system 210 may generate the digital model segments based on solid modeling (e.g., representing the portion as a solid object with volume, surface, and edge data), feature-based modeling (e.g., representing the portion as a set of features, such as holes, pockets, and chamfers), and/or the like.

In some implementations, the computer system 210 may segment the digital model into the digital model segments based on a machining requirement. Segmenting the digital model for post-3D printing machining operations may include the computer system 210 dividing the digital model into distinct regions based on a required machinability. For example, the computer system 210 may identify machining requirements for different portions of the 3D object based on factors such as tolerance, surface finish, and geometric complexity. Based on the types of machining operations, the computer system 210 may classify different regions of the digital model into machinability classes based on the identified machining requirements. The computer system 210 may consider the different machining operations (e.g., drilling, turning, milling, and/or the like), an amount of cutting force, and a level of surface finish when classifying the different regions of the digital model. In some implementations, the computer system 210 may perform a simulation based on historical learning to identify the amount of cutting force, wear and tear of a tool, and/or the like. The computer system 210 may also identify areas of the digital model that require precision or have challenging geometries (e.g., mating surfaces, functional features, or areas with tight tolerances). The computer system 210 may evaluate the material removal rate based on the material specification and a specification of the 3D printer 205, and may identify times required for the machining operations (e.g., harder materials cause slower cutting speeds and lesser productivity).

In some implementations, for segmenting the digital model, the computer system 210 may utilize a combination of geometric analysis and clustering models. For example, the computer system 210 may employ k-means clustering to group similar features based on their geometric properties, such as curvature, surface area, and adjacency. These clusters may then be further refined using edge detection models, such as the Canny edge detector, to accurately delineate the boundaries between different segments. The segmented model may be represented as a hierarchical structure, with each segment containing detailed geometric and topological information.

As shown in FIG. 2D, and by reference number 230, the computer system 210 may determine a handling operation for each of the digital model segments based on one of the portions and one of the machining operations corresponding to each of the digital model segments and to generate handling operations. For example, the computer system 210 may analyze each digital model segment to identify its geometric and topological features, such as surface normal and curvature, edge and corner detection, feature recognition (e.g., holes, pockets, and chamfers), and material properties and machining operation constraints (e.g., cutting speed and feed rate). The computer system 210 may analyze each digital model segment utilizing computer vision and image processing models, geometric and topological analysis tools (e.g., Euler operators and boundary analysis), and feature-based modeling and recognition techniques. For each digital model segment, the computer system 210 may analyze the corresponding machining operation to determine requirements and constraints of the machining operation, such as tool type and toolpath geometry, machining direction and orientation, material removal rate and surface finish requirements, and machine tool capabilities and limitations. The computer system 210 may utilize machining operation simulation and verification, toolpath planning and optimization models, material science and machining dynamics models, and/or the like to determine the requirements and constraints of the machining operation.

In some implementations, to determine the handling operations, the computer system 210 may simulate the machining process using finite element analysis (FEA) to predict the forces and stresses involved. This simulation may help identify optimal gripping points and orientations for each segment, ensuring stability and minimizing deformation during machining. The handling operations may be encoded as a sequence of instructions for a robotic manipulator or a CNC machine, specifying parameters such as grip force, movement trajectory, and toolpath adjustments.

Based on the analysis of the digital model segment and the machining operation, the computer system 210 may determine a handling operation that satisfies geometric constraints (e.g., ensuring that the handling operation can be performed within the spatial constraints of the machine tool and the part), topological constraints (e.g., ensuring that the handling operation preserves the topological relationships between features), machining operation constraints (e.g., ensuring that the handling operation is compatible with the machining operation), and material properties and constraints (e.g., ensuring that the handling operation considers the material properties and machining dynamics). The computer system 210 may determine the handling operation by utilizing combinatorial optimization models (e.g., shortest path planning and knapsack problem), geometric reasoning and spatial reasoning models (e.g., collision detection and path planning), and logic-based reasoning and decision-making techniques. For each digital model segment, the computer system 210 may generate a handling operation that includes a handling type (e.g., gripping, holding, rotating, or translating), a handling geometry (e.g., grasp points, contact surfaces, and trajectory), handling parameters (e.g., speed, acceleration, and force), equipment requirements (e.g., gripper, chuck, and fixture), and/or the like. The computer system 210 may utilize robot motion planning and control models, computer-aided manufacturing and numerical control programming, feature-based modeling and assembly planning techniques, and/or the like to generate the handling operation.

In some implementations, based on a relative position of a machining operation on the 3D printed object, the computer system 210 may determine a historical gripping pattern to identify where the gripping is to be performed. Based on the identified machining operation, and the gripping capability, the computer system 210 may utilize historical data to identify a required gripping force. Based on the identified gripping force and material properties, the computer system 210 may determine whether any deformation may occur due to the gripping and whether additional surface hardening is required.

As shown in FIG. 2E, and by reference number 235, the computer system 210 may train a machine learning model, with historical machining data associated with different machining operations, to generate a trained machine learning model. For example, the computer system 210 may collect historical machining data from various sources, such as machining operation logs, sensor data (e.g., temperature, vibration, and acoustic emission), quality control data (e.g., surface finish and dimensional accuracy), machine tool data (e.g., spindle speed and feed rate), and/or the like. The computer system 210 may preprocess the collected data by cleaning and filtering out noise and inconsistencies, normalizing and scaling the data to a common range, and transforming the data into a format suitable for machine learning models.

The computer system 210 may utilize techniques, such as feature extraction and selection models, domain knowledge and expert input, and automatic feature generation and ranking, to extract relevant features from the preprocessed data. The relevant features may include machining operation parameters (e.g., cutting speed, feed rate, and depth of cut), machine tool conditions (e.g., spindle speed and torque, vibration), material properties (e.g., hardness, density, and thermal conductivity), quality control metrics (e.g., surface finish and dimensional accuracy), and/or the like.

The computer system 210 may select a machine learning model and may configure the machine learning model for training. The machine learning model may include a supervised learning model (e.g., a regression model, a classification model, or a neural network model), an unsupervised learning model (e.g., a clustering model or a dimensionality reduction model), a reinforcement learning model (e.g., a Q-learning model or a policy gradient model), and/or the like. In some implementations, the machine learning model may be a deep neural network (DNN) model with multiple layers, including convolutional layers for feature extraction and fully connected layers for decision making. The DNN model may be trained using a supervised learning approach with labeled data representing various machining operations and outcomes. The training data may include parameters such as cutting speed, feed rate, spindle speed, toolpath geometry, material properties, and resulting surface finish and tool wear. The DNN model may be optimized using techniques such as gradient descent and regularization to prevent overfitting. Additionally, cross-validation may be employed to ensure generalizability of the DNN model.

The computer system 210 may train the machine learning model using the preprocessed and feature-engineered data with an iterative optimization model (e.g., a gradient descent model or a stochastic gradient descent model), batch processing and parallelization techniques, regularization and early stopping techniques, and/or the like. The computer system 210 may monitor and adjust the training process, as needed, to prevent overfitting and underfitting, optimize hyperparameters, and achieve desired performance metrics (e.g., accuracy, precision, and/or recall). The computer system 210 may evaluate and validate the trained machine learning model, using techniques such as cross-validation and holdout methods, metrics calculation (e.g., accuracy, precision, recall, and/or the like), model interpretability and explainability techniques, and/or the like. The computer system 210 may assess performance and generalizability of the machine learning model, and may identify areas for improvement and potential biases.

In some implementations, the historical machining data may include data identifying different types of machining operations; cutting forces required for different types of machining operations; material removal rates and material feed rates for different types of machining operations; wear and tear caused by different types of machining operations; crowd-sourced historical data about performance of digital models post machining processes and portions of the digital models that wear out quicker during usage; life-span requirements; other information gathered post manufacturing; material hardness based on different microstructures of materials; how cooling rates change microstructure and surface parameters; and/or the like.

As shown in FIG. 2F, and by reference number 240, the computer system 210 may process the digital model segments, the portions, the machining operations, and the handling operations, with the trained machine learning model, to generate machinability parameters for the 3D printer 205. For example, the computer system 210 may prepare input data for the trained machine learning model, where the input data may include the digital model segments, the portions, the handling operations, the material properties, and the machining operations. The computer system 210 may format the input data into a suitable structure, such as matrices or tensors for numerical computations, vectors or arrays for categorical or discrete variables, and/or the like. The computer system 210 may extract and transform relevant features from the input data, using techniques such as dimensionality reduction, feature engineering (e.g., polynomial transformation and sinusoidal transformation), and encoding categorical or discrete variables (e.g., one-hot encoding). The computer system 210 may generate, based on the features, a feature space representation of the input data, suitable for processing by the trained machine learning model.

The computer system 210 may process the feature space representation through the trained machine learning model, using techniques such as forward propagation and neural network computations, linear or non-linear regression, and/or classification or clustering. Based on processing the feature space representation, the trained machine learning model may predict machinability parameters, such as cutting speed and feed rate, depth of cut and step-over distance, spindle speed and spindle orientation, toolpath orientation and tool offset, and/or the like. The computer system 210 optimizes the predicted machinability parameters, using techniques such as local search models (e.g., gradient ascent and gradient descent), global search models (e.g., genetic models and simulated annealing), and multi-objective optimization (e.g., Pareto optimization). The computer system 210 may identify the optimal machinability parameters that balance multiple objectives, such as material removal rate and surface finish, dimensional accuracy and precision, and tool life and machining time. In some implementations, the computer system 210 may continuously refine and update the trained machine learning model, incorporating new data and expert knowledge, to maintain optimal performance and accuracy.

As shown in FIG. 2G, and by reference number 245, the computer system 210 may provide the machinability parameters to the 3D printer 205. For example, the computer system 210 may prepare the optimized machinability parameters as output data, suitable for the 3D printer 205. The computer system 210 may format the output data into a structure, such as numerical arrays or vectors, JavaScript object notation (JSON) or extensible markup language (XML) files, and/or the like. The computer system 210 may transfer the optimized machinability parameters to the 3D printer 205, using communication protocols such as a transmission control protocol (TCP) or hypertext transfer protocol (HTTP), serial or parallel interfaces, data synchronization and transfer protocols, and/or the like. The 3D printer 205 may receive the machinability parameters and may print the 3D object based on the machinability parameters. In some implementations, the machinability parameters may enable the 3D printer 205 to produce a high-quality 3D object with improved accuracy and efficiency, by reducing material waste and energy consumption, increasing tool life and reducing tool replacement costs, improving surface finish and dimensional accuracy, and enhancing overall productivity and manufacturing efficiency.

As further shown in FIG. 2G, and by reference number 250, the computer system 210 may receive feedback associated with printing of the 3D object. For example, the 3D printer 205 may be equipped with various sensors that provide real-time data on the printing process, such as temperature sensors (e.g., monitoring a temperature of a print bed, an extruder, and the surrounding environment), pressure sensors (e.g., monitoring the pressure of the extruder and print bed), vibration sensors (e.g., monitoring the vibrations of the print bed and extruder), acoustic sensors (e.g., monitoring the sounds emitted during printing), and/or the like. The computer system 210 may receive the sensor data and may analyze the sensor data to determine if there are any issues or anomalies during the printing process. In some implementations, the 3D printer 205 may be equipped with machine vision cameras that capture images of the printing process, allowing the computer system 210 to monitor the print quality and detect any defects or anomalies, track the movement and position of the extruder and print bed, verify the correct placement and orientation of the printed layers, and/or the like. The computer system 210 may analyze the images and video feeds from the machine vision cameras to detect any issues or abnormalities during the printing process.

In some implementations, the 3D printer 205 may have a control system that provides feedback to the computer system 210 on the printing process. The feedback may include a print completion status (e.g., indicating when a print job is complete or if there are any errors), print quality metrics (e.g., providing data on the quality of the printed object, such as layer adhesion and surface finish), error messages (e.g., alerting the computer system 210 to any issues or errors during the printing process), and/or the like. The computer system 210 may receive this feedback from the printer control system and utilize the feedback to adjust the printing parameters or correct any issues. In some implementations, the computer system 210 may receive feedback from other systems and devices, such as CAD software (e.g., providing feedback on the design and geometry of the printed object), computer-aided manufacturing (CAM) software (e.g., providing feedback on the machining and fabrication process), and enterprise resource planning software (e.g., providing feedback on the production planning and scheduling). The computer system 210 may receive this feedback and use the feedback to adjust the printing parameters or correct any issues.

As further shown in FIG. 2G, and by reference number 255, the computer system 210 may update the machinability parameters based on the feedback and to generate updated machinability parameters. For example, the computer system 210 may analyze the feedback received from the various sources, such as the sensor data, the machine vision, the printer control system, and/or the other systems. The computer system 210 may evaluate the feedback to identify any issues, anomalies, or areas for improvement in the printing process. In some implementations, the computer system 210 may extract and select relevant features from the feedback, using techniques such as dimensionality reduction, feature engineering, and/or feature selection. The computer system 210 may update the machine learning model based on the extracted features and the feedback and utilizing techniques such as online learning and incremental learning, active learning and transfer learning, and/or model-based optimization and machine learning. The computer system 210 may utilize the updated machine learning model to determine updated machinability parameters that minimize errors and improve the printing process. By updating the machinability parameters based on the feedback, the computer system 210 may enable the 3D printer 205 to improve the printing process, reduce errors, and enhance the quality of the printed objects.

As further shown in FIG. 2G, and by reference number 260, the computer system 210 may provide the updated machinability parameters to the 3D printer 205. For example, the computer system 210 may prepare the updated machinability parameters as output data, suitable for the 3D printer 205. The computer system 210 may format the output data into a structure, such as numerical arrays or vectors, JSON or XML files, and/or the like. The computer system 210 may transfer the updated machinability parameters to the 3D printer 205, using communication protocols such as TCP or HTTP, serial or parallel interfaces, data synchronization and transfer protocols, and/or the like. The 3D printer 205 may receive the updated machinability parameters and may update the printing of the 3D object based on the updated machinability parameters.

In this way, the computer system (e.g., the computer system 210) controls machinability in metal 3D printing. For example, the computer system may provide optimized metal 3D printing for machinability. The computer system may efficiently identify relevant machining operations and machinability parameters, which may lead to less wear and tear on 3D printers. The computer system may also optimize instructions used by a 3D printer to create the 3D object. By optimizing the machining operations, the machinability parameters, and the instructions, the computer system may minimize 3D printer energy consumption, decrease failure rates in metal 3D printing, and improve print throughput and yield rates. Additionally, the computer system may utilize a feedback control loop to iteratively refine the machinability parameters used by the 3D printer, which may reduce latency times, improve print quality, and maintain optimal machining conditions during the 3D printing process. Thus, the computer system conserves computing resources, networking resources, and/or the like that would otherwise have been consumed by causing rapid tool wear in metal 3D printers, frequently replacing metal 3D printers due to rapid tool wear, constantly maintaining metal 3D printers, failing to properly perform different machining operations with metal 3D printers, and/or the like.

As indicated above, FIGS. 2A-2G are provided as an example. Other examples may differ from what is described with regard to FIGS. 2A-2G. The number and arrangement of devices shown in FIGS. 2A-2G are provided as an example. In practice, there may be additional devices, fewer devices, different devices, or differently arranged devices than those shown in FIGS. 2A-2G. Furthermore, two or more devices shown in FIGS. 2A-2G may be implemented within a single device, or a single device shown in FIGS. 2A-2G may be implemented as multiple, distributed devices. Additionally, or alternatively, a set of devices (e.g., one or more devices) shown in FIGS. 2A-2G may perform one or more functions described as being performed by another set of devices shown in FIGS. 2A-2G.

FIG. 3 is a flowchart of an example process 300 associated with controlling machinability in metal 3D printing. One or more process blocks of FIG. 3 are performed by a computer system (e.g., computer 102, the computer system 210, and/or a computer system of the 3D printer 205) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or analysis code 150.

As shown in FIG. 3, process 300 may include receiving a digital model of a 3D object to be printed with a metal by a 3D printer (block 310). For example, the computer system may receive a digital model of a 3D object to be printed with a metal by a 3D printer, as described above.

As further shown in FIG. 3, process 300 may include analyzing the digital model to identify portions of the 3D object to be machined and machining operations to be performed on the portions (block 320). For example, the computer system may analyze the digital model to identify portions of the 3D object to be machined and machining operations to be performed on the portions, as described above.

As further shown in FIG. 3, process 300 may include segmenting the digital model based on the portions and the machining operations and to generate digital model segments (block 330). For example, the computer system may segment the digital model based on the portions and the machining operations and to generate digital model segments, as described above.

As further shown in FIG. 3, process 300 may include determining a handling operation for each of the digital model segments based on one of the portions and one of the machining operations corresponding to each of the digital model segments and to generate handling operations (block 340). For example, the computer system may determine a handling operation for each of the digital model segments based on one of the portions and one of the machining operations corresponding to each of the digital model segments and to generate handling operations, as described above. In some implementations, determining the handling operation for each of the digital model segments includes identifying how the 3D object is to be gripped by the 3D printer for each of the digital model segments.

As further shown in FIG. 3, process 300 may include processing the digital model segments, the portions, the machining operations, and the handling operations, with a machine learning model, to generate machinability parameters for the 3D printer (block 350). For example, the computer system may process the digital model segments, the portions, the machining operations, and the handling operations, with a machine learning model, to generate machinability parameters for the 3D printer, as described above. In some implementations, processing the digital model segments, the portions, the machining operations, and the handling operations, with the machine learning model, to generate the machinability parameters includes identifying microstructure formations on the portions, and generating the machinability parameters based on the microstructure formations. In some implementations, identifying the microstructure formations on the portions includes utilizing material properties and a design associated with the 3D object to identify the microstructure formations on the portions.

As further shown in FIG. 3, process 300 may include providing the machinability parameters to the 3D printer (block 360). For example, the computer system may provide the machinability parameters to the 3D printer, as described above. In some implementations, the machinability parameters cause the 3D printer to print the 3D object with the metal. In some implementations, the machinability parameters cause the 3D printer to one or more of adjust a print speed of the 3D printer, adjust material temperature during printing of the 3D object, or control thermal management during printing of the 3D object.

In some implementations, process 300 includes training the machine learning model with historical machining data associated with different machining operations and prior to processing the digital model segments, the portions, the machining operations, and the handling operations with the machine learning model. In some implementations, process 300 includes receiving feedback associated with printing of the 3D object from the 3D printer, updating the machinability parameters based on the feedback and to generate updated machinability parameters, and providing the updated machinability parameters to the 3D printer. In some implementations, the feedback includes data identifying microstructure formation associated with printing of the 3D object.

In some implementations, process 300 includes controlling thermal management during printing of the 3D object. In some implementations, process 300 includes creating a digital twin model for the metal, and collecting, for the digital twin model, data on property changes of the metal during utilization of the machinability parameters by the 3D printer. In some implementations, process 300 includes receiving additional data on the property changes of the metal from multiple crowdsourcing entities, and updating the digital twin model based on the additional data. In some implementations, process 300 includes collecting historical data on performance metrics for a plurality of 3D objects created by 3D printer, generating microstructure data based on the historical data, and training the machine learning model with the microstructure data.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a digital model of a three-dimensional (3D) object to be printed with a metal by a 3D printer;
analyzing the digital model to identify portions of the 3D object to be machined and machining operations to be performed on the portions;
segmenting the digital model based on the portions and the machining operations and to generate digital model segments;
determining a handling operation for each of the digital model segments based on one of the portions and one of the machining operations corresponding to each of the digital model segments and to generate handling operations;
processing the digital model segments, the portions, the machining operations, and the handling operations, with a machine learning model, to generate machinability parameters for the 3D printer; and
providing the machinability parameters to the 3D printer.

2. The method of claim 1, wherein the machinability parameters cause the 3D printer to print the 3D object with the metal.

3. The method of claim 1, further comprising:
training the machine learning model with historical machining data associated with different machining operations and prior to processing the digital model segments, the portions, the machining operations, and the handling operations with the machine learning model.

4. The method of claim 1, further comprising:
receiving feedback associated with printing of the 3D object from the 3D printer;
updating the machinability parameters based on the feedback and to generate updated machinability parameters; and
providing the updated machinability parameters to the 3D printer.

5. The method of claim 4, wherein the feedback includes data identifying microstructure formation associated with printing of the 3D object.

6. The method of claim 1, wherein processing the digital model segments, the portions, the machining operations, and the handling operations, with the machine learning model, to generate the machinability parameters comprises:
identifying microstructure formations on the portions; and
generating the machinability parameters based on the microstructure formations.

7. The method of claim 6, wherein identifying the microstructure formations on the portions comprises:
utilizing material properties and a design associated with the 3D object to identify the microstructure formations on the portions.

8. A computer system, comprising:
a processor set;
one or more computer-readable storage media; and
program instructions stored on the one or more computer-readable storage media to cause the processor set to perform operations comprising:
receiving a digital model of a three-dimensional (3D) object to be printed with a metal by a 3D printer;
analyzing the digital model to identify portions of the 3D object to be machined and machining operations to be performed on the portions;
segmenting the digital model based on the portions and the machining operations and to generate digital model segments;
determining a handling operation for each of the digital model segments based on one of the portions and one of the machining operations corresponding to each of the digital model segments and to generate handling operations;
processing the digital model segments, the portions, the machining operations, and the handling operations, with a machine learning model, to generate machinability parameters for the 3D printer; and
providing the machinability parameters to the 3D printer to cause the 3D printer to print the 3D object with the metal.

9. The computer system of claim 8, further comprising:
controlling thermal management during printing of the 3D object.

10. The computer system of claim 8, wherein the machinability parameters cause the 3D printer to one or more of adjust a print speed of the 3D printer, adjust material temperature during printing of the 3D object, or control thermal management during printing of the 3D object.

11. The computer system of claim 8, further comprising:
creating a digital twin model for the metal; and
collecting, for the digital twin model, data on property changes of the metal during utilization of the machinability parameters by the 3D printer.

12. The computer system of claim 11, further comprising:
receiving additional data on the property changes of the metal from multiple crowdsourcing entities; and
updating the digital twin model based on the additional data.

13. The computer system of claim 8, wherein determining the handling operation for each of the digital model segments comprises:
identifying how the 3D object is to be gripped by the 3D printer for each of the digital model segments.

14. The computer system of claim 8, further comprising:
collecting historical data on performance metrics for a plurality of 3D objects created by 3D printer;
generating microstructure data based on the historical data; and
training the machine learning model with the microstructure data.

15. A computer program product, comprising:
one or more computer-readable storage media; and
program instructions stored on the one or more computer-readable storage media to perform operations, the operations comprising:
receiving a digital model of a three-dimensional (3D) object to be printed with a metal by a 3D printer;
analyzing the digital model to identify portions of the 3D object to be machined and machining operations to be performed on the portions;
segmenting the digital model based on the portions and the machining operations and to generate digital model segments;
determining a handling operation for each of the digital model segments based on one of the portions and one of the machining operations corresponding to each of the digital model segments and to generate handling operations;
processing the digital model segments, the portions, the machining operations, and the handling operations, with a machine learning model, to generate machinability parameters for the 3D printer;
providing the machinability parameters to the 3D printer;
receiving feedback associated with printing of the 3D object from the 3D printer;
updating the machinability parameters based on the feedback and to generate updated machinability parameters; and
providing the updated machinability parameters to the 3D printer.

16. The computer program product of claim 15, wherein the feedback includes data identifying microstructure formation associated with printing of the 3D object.

17. The computer program product of claim 15, wherein processing the digital model segments, the portions, the machining operations, and the handling operations, with the machine learning model, to generate the machinability parameters comprises:
identifying microstructure formations on the portions; and
generating the machinability parameters based on the microstructure formations.

18. The computer program product of claim 17, wherein identifying the microstructure formations on the portions comprises:
utilizing material properties and a design associated with the 3D object to identify the microstructure formations on the portions.

19. The computer program product of claim 15, further comprising:
creating a digital twin model for the metal;
collecting, for the digital twin model, data on property changes of the metal during utilization of the machinability parameters by the 3D printer;
receiving additional data on the property changes of the metal from multiple crowdsourcing entities; and
updating the digital twin model based on the additional data.

20. The computer program product of claim 15, wherein determining the handling operation for each of the digital model segments comprises:
identifying how the 3D object is to be gripped by the 3D printer for each of the digital model segments.
